(19) United States
(12) Patent Application Publication
(10) Pub. No.: US 2015/0029524 A1
(43) Pub. Date: Jan. 29, 2015

(54) HOST APPARATUS, METHOD FOR PROCESSING FILE THEREOF, AND IMAGE FORMING APPARATUS

(71) Applicant: Samsung Electronics Co., Ltd., Suwon-si (KR)

(72) Inventors: Nam-ju SHIN, Suwon-si (KR); Hyun-soo OH, Suwon-si (KR); Woo-jun CHUNG, Suwon-si (KR)

(73) Assignee: Samsung Electronics Co., Ltd., Suwon-si (KR)

(21) Appl. No.: 14/340,955

(22) Filed: Jul. 25, 2014

(30) Foreign Application Priority Data
Jul. 26, 2013 (KR) 10-2013-0088903

(51) Int. Cl. G06K 15/02

(52) U.S. Cl. CPC G06K 15/1835; G06K 15/1802
USPC 358/1.9

(57) ABSTRACT

A host apparatus connectable to an image forming apparatus and a method are provided. The host apparatus includes a storage configured to store a portable document format (PDF) file, an object extractor configured to extract at least one object that requires color conversion from among objects included in the stored PDF file, a color conversion processor configured to perform color conversion process for each of the extracted objects by using a color conversion function corresponding to each of the extracted objects, and a communication interface configured to transmit the PDF file where the color conversion process is performed to the image forming apparatus.

### CROSS-REFERENCE TO RELATED APPLICATIONS

This application is related to, and claims priority to, Korean Patent Application No. 10-2013-0088903, filed on Jul. 26, 2013 in the Korean Intellectual Property Office, the disclosure of which is incorporated herein by reference in its entirety.

### BACKGROUND

1. Field

Exemplary embodiments relate to a host apparatus, a method for processing a file thereof, and an image forming apparatus, and more particularly, to an apparatus that performs color conversion for at least one object included in a portable document format (PDF) file, and a method thereof.

2. Description of the Related Art

As the internet increases in popularity, an amount of accessible data increases. Hence, a user that uses the internet may be able to view a file using the internet as soon as the file is saved regardless of a location where the file originated, even though the user may be on the other side of world.

Formats of document that are accessible using the internet are various. In particular, use of a portable document format (PDF) file has substantially increased. A user having a PDF reader program (for example, Acrobat reader program by Adobe Systems Corporation) may be able to read PDF files easily in a computing environment.

An exemplary PDF file includes at least one or more objects. When a plurality of objects are included in a PDF file, each object may include state information or color information that is different from each other, according to an interest of a producer, a time of production, a production method, or a computing environment, for example. Such characteristics of an object may not meet a user who reads a PDF file needs and/or desires. Thus, a user may attempt to edit the PDF file. However, an editing function of a PDF file may be an application that is restricted. Thus, an editing function of a PDF file may be limited to editing of an entire unit of the PDF file. Accordingly, a user may not be able to edit the PDF file in an object unit.

### SUMMARY

Additional aspects and/or advantages will be set forth in part in the description which follows and, in part, will be apparent from the description, or may be learned by practice of the invention.

An aspect of an exemplary embodiment relates to a host apparatus that extracts at least one object that requires color conversion from a PDF file, and performs the color conversion for each of the extracted objects, a method for processing a file thereof, and an image forming apparatus.

A host apparatus connectable to an image forming apparatus according to an exemplary embodiment includes a storage configured to store a portable document format (PDF) file, an object extractor configured to extract at least one object that requires color conversion from among objects included in the stored PDF file, a color conversion processor configured to perform a color conversion process for each of the extracted objects by using a color conversion function corresponding to each of the extracted objects, and a communication interface configured to transmit the PDF file where the color conversion process is performed to the image forming apparatus.

An object extractor may include a first extractor configured to respectively determine whether all objects included in the PDF file include at least one predetermined object characteristic, and extract an object including the at least one object characteristic according to a determined result, and a second extractor configured to, upon at least one object being selected from a list of the objects extracted from the first extractor, extract the at least one selected object.

The at least one predetermined object characteristic may be at least one of an image characteristic, a text characteristic, a graphic characteristic, and a color characteristic.

The host apparatus may include a user interface configured to provide a user interface screen for receiving a selection of a color conversion function corresponding to each of the extracted objects.

The color conversion processor may include a color conversion function generator configured to analyze characteristic of the extracted objects, and generate a standard color conversion function corresponding to each of the extracted objects, a color conversion function provider configured to, upon a color conversion function different from the standard color conversion function being selected for each of the objects through the user interface screen, provide the selected color conversion function, and upon the standard color conversion function being selected, provide the standard color conversion function, and a processor configured to perform a color conversion process for each of the extracted objects by using a color conversion function provided from the color conversion function provider.

The host apparatus may include a controller configured to control the user interface to display a preview screen where one of the color conversion function and the standard color conversion function selected through the user interface screen is applied to the object.

A controller may store a PDF file where color conversion process is performed by the color conversion processor in the storage.

The color conversion function may include at least one of a brightness characteristic value, a contrast characteristic value, a saturation characteristic value, and a color balance characteristic value to be used in color conversion of each of the extracted objects.

A host apparatus connectable to an image forming apparatus includes a user interface configured to display a list of objects included in a PDF file, and receive a selection of a method of processing color conversion for each of the objects and a controller configured to control the user interface to display a preview screen where the selected color conversion processing method is applied to each of the objects. A host apparatus connectable to an image forming apparatus may control the user interface to display a list of objects included in a PDF file, and with respect to the user interface configured to receive a selection of a color conversion processing method for each of the objects and each of the objects, to display a preview screen where the selected color conversion processing method is applied.

The controller may control the user interface to display an original screen of the object on a side of the preview screen.

Upon one of the standard color conversion function for each of the objects and color conversion function that is different from the standard color conversion function being selected, the user interface may select the selected color conversion function as the color conversion processing method.

The selected color conversion function may include at least one of a brightness characteristic value, a contrast characteristic value, a saturation characteristic value, and a color balance characteristic value to be used in color conversion of each of the extracted objects.

An image forming apparatus according to an exemplary embodiment includes an object extractor configured to extract at least one object that requires color conversion from among objects included in a stored PDF file, a color conversion processor configured to perform a color conversion process for each of the extracted objects by using a color conversion function corresponding to each of the extracted objects, and an output unit configured to output a PDF file where the color conversion process is performed.

A method for processing file of a host apparatus connectable to an image forming apparatus according to an exemplary embodiment includes extracting at least one object that requires color conversion from among objects included in a stored PDF file, performing a color conversion process for each of the extracted objects by using a color conversion function corresponding to each of the extracted objects, and transmitting a PDF file where the color conversion process is performed to the image forming apparatus.

The extracting at least one object may include respectively determining whether all objects included in the PDF file include at least one predetermined object characteristic, extracting an object including the at least one object characteristic according to a determined result, and upon at least one object being selected from a list of the extracted objects, extracting the at least one selected object.

The at least one predetermined object characteristic may be at least one of an image characteristic, a text characteristic, a graphic characteristic, and a color characteristic.

The performing a color conversion process for each of the extracted objects may includes analyzing characteristic of the extracted objects and generating a standard color conversion function corresponding to each of the extracted objects, upon a color conversion function that is different from the standard color conversion function being selected for each of the objects through the user interface screen, providing the selected color conversion function, and upon the standard color conversion function being selected, providing the standard color conversion function, and performing a color conversion process for each of the extracted objects by using the provided color conversion function.

The performing a color conversion process for each of the extracted objects may include displaying a preview screen where any one of the color conversion function and the standard color conversion selected through the user interface screen function is applied to the object.

The method may include displaying a PDF file where the color conversion process is performed on a screen and storing the PDF file where the color conversion process is performed on the storage.

The color conversion function may include at least one of a brightness characteristic value, a contrast characteristic value, a saturation characteristic value, and a color balance characteristic value to be used in color conversion of each of the extracted objects.

A non-transitory computer readable recording medium includes a program executing the method.

### BRIEF DESCRIPTION OF THE DRAWINGS

The above and/or other aspects of the exemplary embodiments will be more apparent by describing certain exemplary embodiments with reference to the accompanying drawings, in which:

FIG. 1 illustrates a host apparatus according to an exemplary embodiment;

FIG. 2 illustrates a host apparatus according to an exemplary embodiment;

FIG. 3 illustrates an image forming apparatus according to an exemplary embodiment;

FIG. 4 through FIG. 6 illustrate a user interface screen according to an exemplary embodiment;

FIG. 7 illustrates a method for processing a file according to an exemplary embodiment;

FIG. 8 illustrates a method for processing a file according to an exemplary embodiment; and

FIG. 9 illustrates a method for outputting a file according to an exemplary embodiment.

### DETAILED DESCRIPTION

Exemplary embodiments are described in detail with reference to the accompanying drawings.

Like drawing reference numerals are used for like elements, even in different drawings. The matters defined in the description, such as detailed construction and elements, are provided to assist in a comprehensive understanding of exemplary embodiments. However, exemplary embodiments can be practiced without those specifically defined matters.

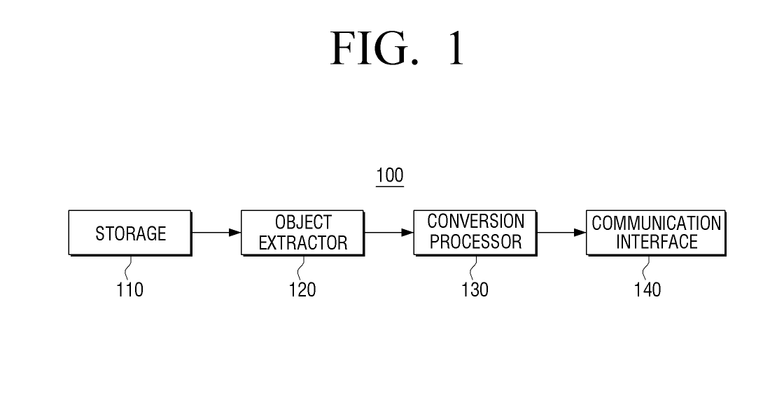

FIG. 1 illustrates a host apparatus according to an exemplary embodiment. A host apparatus may be a desktop computer, a laptop computer, a mobile device, and the like, which may be connected to an image forming apparatus.

Referring to FIG. 1, a host apparatus 100 may include a storage 100, an object extractor 120, a conversion processor 130 e.g., a color conversion processor, and a communication interface 140.

The storage 110 stores various programs or applications that may be required to operate the host apparatus 100. The storage 110 may store PDF files. The PDF files may be files downloaded and stored through an internet network, and/or may be files produced in the host apparatus 100.

The object extractor 120 extracts at least one object that requires the conversion, e.g., color conversion from among objects included in a PDF file. The PDF file may be a PDF file selected by a user from the PDF files stored in the storage 110.

The conversion processor 130 performs a conversion process, e.g., a color conversion process for an extracted object, e.g., each of the extracted objects by using a conversion function, e.g., a color conversion function corresponding to an object, e.g., each of the objects extracted from the object extractor 120. For example, the conversion processor 130 may perform a color conversion for an object by adjusting at least one characteristic value of the brightness characteristic value, the contrast characteristic value, the saturation characteristic value, and the color balance characteristic value, according to a color conversion function.

The communication interface 140 performs communication with an image forming apparatus. The communication interface 140 may be connected to the image forming apparatus through a local area network (LAN) and an internet network, and may be connected to the image forming apparatus through the USB port.

The communication interface 140 transmits a PDF file where the conversion process is performed to the image forming apparatus. Accordingly, the communication interface 140 may output the PDF file where the conversion process is performed on a printing medium (for example, printing paper) through the image forming apparatus.

As the host apparatus 100 according to an exemplary embodiment extracts at least one object that requires the conversion, e.g., color conversion from the PDF file, and performs the conversion for each of the extracted objects, it is possible to perform the conversion process, e.g., color conversion process for only an object that requires the conversion, e.g., color conversion without editing the entire PDF file.

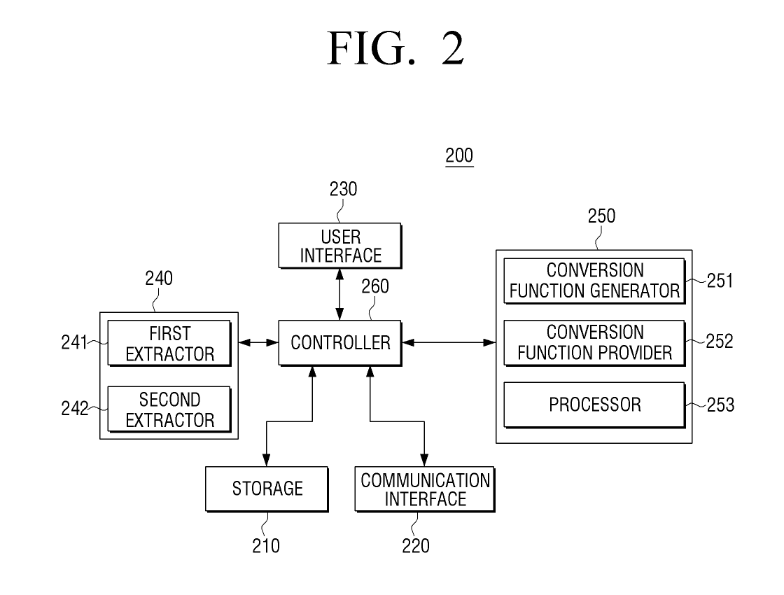

FIG. 2 illustrates a host apparatus according to an exemplary embodiment.

Referring to FIG. 2, a host apparatus 200 may include a storage 210, a communication interface 220, a user interface 230, an object extractor 240, a conversion processor 250, and a controller 260.

The storage 210 may store PDF files.

The communication interface 220 may communicate with an image forming apparatus.

The user interface 230 displays a user interface screen related to the conversion process, and receives a user input signal. The user interface 230 may include a user input function and a display function, and may be implemented as a touch screen, for example.

The object extractor 240 extracts at least one object that requires the conversion, e.g., the color conversion from among objects included in a PDF file. The object extractor 240 may include a first extractor 241 and a second extractor 242.

The first extractor 241 may extract objects, e.g., all objects included in the PDF file, and may respectively determine whether the objects, e.g., all of the objects included in the PDF file include at least one predetermined object characteristic. A predetermined object characteristic may be defined as at least one of the image characteristic, the text characteristic, the graphic characteristic, and the color characteristic. A color characteristic may be a primary color that is included in an object. When the object includes a single color, the primary color may be the color, and when the object includes a plurality of colors, the primary color may be a color having a high proportion among the plurality of colors.

The first extractor 241 may determine whether the objects include at least one object characteristic of the image characteristic, the text characteristic, the graphic characteristic, and the color characteristic, but not limited thereto. According to an exemplary method, the first extractor 241 may determine whether all objects include at least one characteristic of the image characteristic, the text characteristic, and the graphic characteristic, and may determine whether the objects including one of the image characteristic, the text characteristic, and the graphic characteristic include the color characteristic. That is, the first extractor 241 may extract objects including the color characteristic from among the objects including any one of the image characteristic, the text characteristic, and the graphic characteristic.

Accordingly, the first extractor 241 may respectively determine whether the objects extracted from an area, e.g., from a top to a bottom of a first page include the aforementioned object characteristic, and may perform an object extracting operation of extracting at least one object including the object characteristic. Such object extracting operation may be performed, for example, to a last page of the PDF file.

When at least one object is selected from the objects e.g., from a list of the objects extracted from the first extractor 241, the second extractor 242 may extract at least one selected object. Upon an object being extracted from the first extractor 241, a screen, e.g., list screen where the extracted objects are arranged may be displayed on a screen through the user interface 230. The list screen of the objects may be generated by the controller 260.

When at least one object is selected from the list screen of the objects by a user, the second extractor 242 may extract the at least one selected object as an objects that requires the color conversion.

That is, the list screen of the objects may be provided so that the color conversion is processed for only an object that is selected by a user among the objects extracted from the first extractor 241, e.g., not all of the objects extracted from the first extractor 241.

The conversion processor 250 performs the color conversion process for an extracted object, e.g., each of the extracted objects by using a color conversion function corresponding to each of the objects extracted from the object extractor 240. The conversion processor 250 may include a conversion function generator 251, e.g., color conversion function generator, a conversion function provider 252, e.g., a color conversion function provider, and a processor 253.

The conversion function generator 251 may analyze a characteristic of the objects extracted from the object extractor 240, and may generate a standard color conversion function corresponding to each of the extracted objects. The characteristic of the object may be at least one of the image characteristic, the text characteristic, the graphic characteristic, and the color characteristic.

The conversion function generator 251 may generate a standard color conversion function based on Gamut mapping. A color conversion function may be generated by using any one of Rendering Intent, Perceptual Rendering Intent, Saturation Rendering Intent, Relative Colorimetric Rendering Intent, Absolute Colorimetric Rendering Intent, and Special Rendering Intent based on Gamut mapping. Gamut adjusting parameters to be used in the color conversion may be provided to generate a color conversion function.

The conversion function generator 251 may generate a standard color conversion function corresponding to each of objects by considering a characteristic of an object. A standard color conversion function may be a general color conversion function that is applicable to the color conversion for a certain object. For example, when an object is a picture including a person, the object has the image characteristic, and more particularly, has the color characteristic including a skin color. Accordingly, the conversion function generator 251 may generate a standard color conversion function that is applicable to the color conversion for the person including a skin color.

The conversion function provider 252 may provide a color conversion function to be applied to the color conversion for each of the objects extracted from the object extractor 240. The color conversion for an object may be performed by using a standard color conversion function generated by the color conversion function generator 251, but even though the color conversion for the object is performed by using the standard color conversion function, a user may be unsatisfied with the processed object. Accordingly, when a standard color conversion function for an object is generated by the conversion generator 251, a user interface screen for receiving a selection of a color conversion function for each of the objects may be displayed through the user interface 230. The user interface screen may be generated by the controller 260.

The user interface screen may include the list of the objects extracted from the object extractor 240 and a standard color conversion function for each of the objects, and may display an area for selecting a color conversion function different from a standard color conversion function.

When any one of the standard color conversion function and the different color conversion function is selected with respect to each of the objects, the controller 260 may control the user interface 230 to display a preview screen where the selected color conversion function is applied on the user interface screen,. The controller 260 may control the user interface 230 to display an original screen of the object together with the preview screen thereof so that a user is able to distinguish the preview screen from the original screen.

The processor 253 may perform the color conversion process for each of the extracted objects by using the color conversion function provided by the conversion function provider 252. The color conversion process refers to a process of adjusting at least one of the brightness characteristic value, the contrast characteristic value, the saturation characteristic value, and the color balance characteristic value of an object according to a provided color conversion function corresponding to each object.

The controller 260 may control the communication interface 220 to transmit a PDF file where the color conversion process is performed to the image forming apparatus in response to a printing command for the PDF file.

The controller 260 may store the PDF file where the color conversion process is performed through the color conversion processor 250 in the storage 210, and may display the PDF file where the color conversion process is performed, in the user interface 230.

When a color conversion function selected by a user is applied to an object, the host apparatus 200 according to above exemplary embodiment may provide a result through the preview screen, and may receive a selection of the color conversion function according to tendency or demand of the user. The host apparatus 200 may perform the color conversion process for only an object that requires the color conversion without editing the entire PDF file.

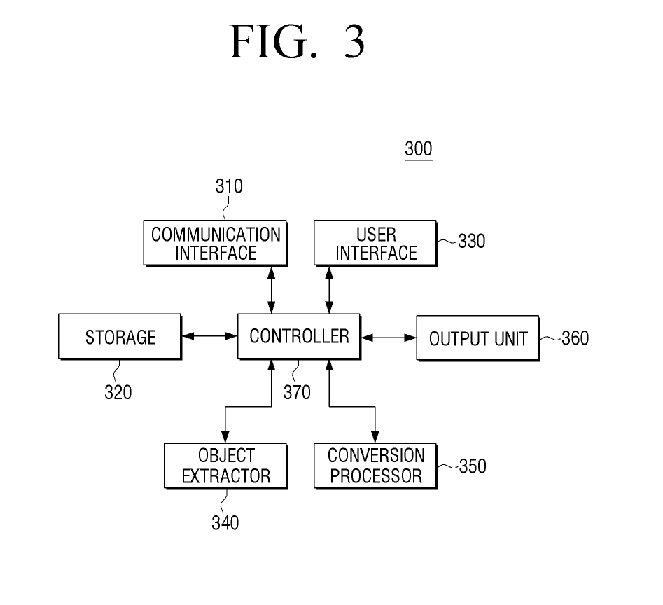

FIG. 3 illustrates an image forming apparatus according to an exemplary embodiment. Referring to FIG. 3, an image forming apparatus 300 includes a communication interface 310, a storage 320, a user interface 330, an object extractor 340, a conversion processor 350 e.g., a color conversion processor, an output unit 360, and a controller 370.

The image forming apparatus 300 may be a printer, or a multifunctional device that is connected to a host apparatus.

The communication interface 310 may communicate with a host apparatus, and receives a PDF file from the host apparatus. The communication interface 310 may download a PDF file through the internet.

The storage 320 may store a PDF file.

The output unit 360 outputs a PDF file on a printing paper. The image forming apparatus 300 may output the PDF file as it is, and may output the PDF file by performing the color conversion for the PDF file. Accordingly, a screen for inquiring as to whether the color conversion for the PDF file needs to be performed may be displayed through the user interface 330 before the PDF file is outputted. When a signal for performing the color conversion for the PDF file is inputted, the image forming apparatus 300 may perform the color conversion for the PDF file, and may output the PDF file.

The image forming apparatus 300 may include the object extractor 340 and the conversion processor 350 for the color conversion process. The object extractor 340 and the color conversion processor 350 perform operations the same as the operations of the object extractor 240 and the color conversion processor 250 illustrated in FIG. 2, and the controller 370 also performs the substantially same operations.

The controller 370 may control the output unit 370 to output a PDF file where the color conversion process is performed by the color conversion processor 350.

The image forming apparatus 300 according to an exemplary embodiment may perform the color conversion process for a PDF file transmitted through a host apparatus or the internet network in an object unit, and may output the PDF file on a printing paper.

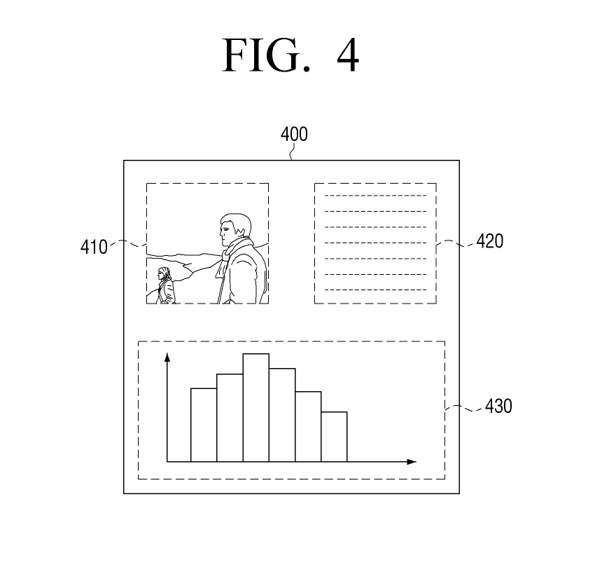

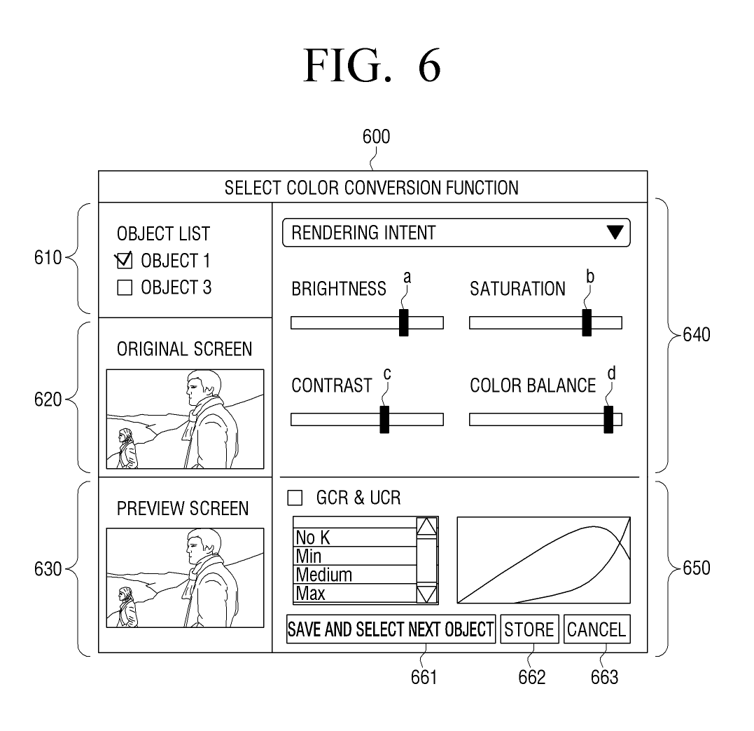

FIG. 4—FIG. 6 illustrate exemplary user interface screens according to an exemplary embodiment.

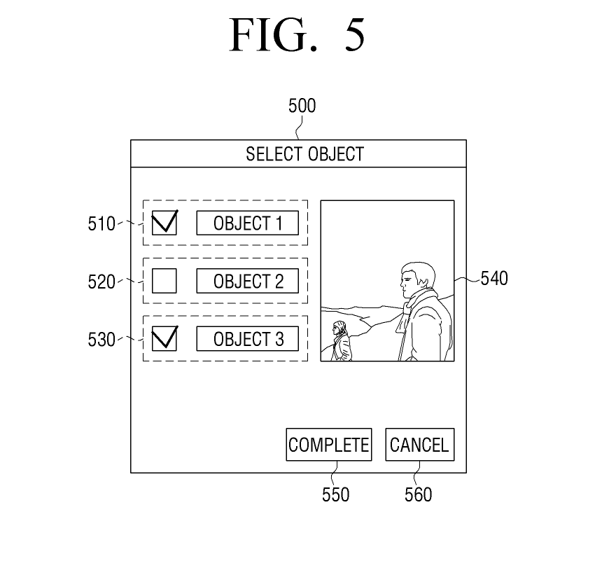

FIG. 4 illustrates a screen displaying a PDF file 400, and FIG. 5 illustrates a list screen 500 of objects extracted from a PDF file. FIG. 6 illustrates a selection screen 600 for selecting a color conversion function to be applied to an object selected from the list screen, for example, illustrated in FIG. 5.

Referring to FIG. 4, the PDF file 400 may include an object 1 (410) having an image characteristic, an object 2 (420) having a text characteristic, and an object 3 (430) having a graphic characteristic. Accordingly, the host apparatus or the image forming apparatus may extract the objects 1 through 3 (410, 420, and 430) having the object characteristics from the PDF file 400.

Although FIG. 4 illustrates a PDF file 400 that includes three objects 410, 420, and 430, the PDF file 400 may include a plurality of pages, and each page may include a plurality of objects.

Even though the PDF file 400 may include a plurality of objects, unless one of the objects includes at least one predetermined object characteristic, the object may not require the color conversion, and thus the object may not be extracted.

When the objects 1 through 3 (410, 420, and 430) are extracted from the PDF file 400 as illustrated in FIG. 4, the host apparatus 100, 200 or the image forming apparatus 300 may display the list screen 500 where objects 1 through 3 (510, 520, and 530) are arranged on a screen, for example, as illustrated in FIG. 5. Accordingly, a user is able to select one or more objects that require the color conversion from among the objects 1 through 3 (510, 520, and 530) that are arranged on the list screen 500.

When a user selects the object 1 (510), a screen corresponding to the object 1 (510) may be displayed on an object displaying area 540. When the user selects the object 3 (530) while the object 1 (510) is also selected, a screen corresponding to the object 3 (530) may be displayed on the object displaying area 540.

Upon all of objects that require the color conversion being selected from the list screen 500, the user may complete the selection of objects by pressing a complete button 550 that may be disposed on a lower side of the list screen 500.

When the user does not wish to perform the color conversion process for the PDF file, the user may cancel the selection of objects by pressing a cancel button 560, for example, disposed on the lower side of the list screen 500.

When the object 1 (510) and the object 3 (530) are selected from the list screen 500 illustrated in FIG. 5, the host apparatus 100, 200 or the image forming apparatus 300 may generate a standard color conversion function for each object by analyzing the characteristics of the object 1 (510) and the object 3 (530).

The color conversion process for the object 1 (510) and the object 3 (530) may be performed by using the standard color conversion function. Even though the color conversion process for the object 1 (510) and the object 3 (530) may be performed by using the standard color conversion function, a user may not obtain a desired result. Accordingly, as illustrated in FIG. 6, when a standard color conversion function is generated, the host apparatus 100, 200 or the image forming apparatus 300 may display a selection screen 600 for receiving a selection of a color conversion function for each of the objects, for example, object 1 (510) and the object 3 (530).

The selection screen 600 may include an object list area 610, an original screen displaying area 620, a preview screen displaying area 630, and a color conversion function selecting area 640.

The object list area 610 is an area where the objects selected from the list screen 500 illustrated in FIG. 5 may be arranged, and includes the object 1 and the object 3.

When an object is selected from the object list area 610, the original screen displaying area 620 displays an original screen of the selected object. For example, when the object 1 is selected from the object list area 610, the original screen displaying area 620 may display an original screen corresponding to the object 1.

The color conversion function selecting area 640 is an area for receiving a selection of a color conversion function to be applied to objects included in the object list area 610. When the selection screen 600 is displayed in a form of a pop-up window, the color conversion function selecting area 640 may display nothing.

When the object 1 is selected from the object list area 610, a standard color conversion function for the object 1 may be displayed on the color conversion function selecting area 640. The standard color conversion function for the object 1 may be a general color conversion function that is applicable to the color conversion for the object 1.

That is, a standard color conversion function may be generated according to Rendering Intent, and may include the brightness characteristic value, the contrast characteristic value, the saturation characteristic value, and the color balance characteristic value to be used in the color conversion for the object 1. The characteristic values may be composed of general characteristic values that are applicable to the color conversion for the object 1.

A user may change the brightness characteristic value, the contrast characteristic value, the saturation characteristic value, and the color balance characteristic value by moving bars of a, b, c, and d included in the color conversion function selecting area 640. When at least one of the bars of a, b, c, and d is moved, a color conversion function may be changed to a different color conversion function, not a standard color conversion function.

The preview screen displaying area 630 is an area for displaying a preview screen where a color conversion function for an object selected from the object list area 610 is applied to the object. Accordingly, when the object 1 is selected from the object list area 610, the host apparatus 100, 200 or the image forming apparatus 300 may display a preview screen where a standard color conversion function for the object 1 is applied to the object 1 on the preview screen displaying area 630. When a user moves at least one of the bars of a, b, c, and d, a preview screen where at least one of the brightness characteristic value, the contrast characteristic value, the saturation characteristic value, and the color balance characteristic value of the object 1 is changed may be displayed on the preview screen displaying area 630 in response of movement of one or more of the bars. Accordingly, the user may change the color conversion function according to their needs or desires while watching the preview screen.

The selection screen 600 may include a selection area 650 for selecting GCR (Gray Component Replacement) and UCR (Under Color Removal). Through the selection area 650, a user may determine whether it is necessary to change a gray element included in an object and remove a under color, and if necessary, what degree should be applied thereto.

When a color conversion function to be applied to the object 1 is determined in FIG. 6, the user may press a “Save and select next object” button 661 that may disposed on a lower side of the selection screen 600. The object 1 and the color conversion function to be applied to the object 1 may be matched with each other, and stored in storage.

When the user determines a color conversion function to be applied to the object 3, and thus the color conversion functions for all objects included in the object list area 610 are designated, the user may press a “Store” button 662 so that the object 3 and the color conversion function to be applied to the object 3 are matched with each other and stored in the storage.

The user interface screens 400, 500, and 600 according to an exemplary embodiment help the user to select objects and select a color conversion function for each of the objects more easily. The user interface screens 400, 500, and 600 may provide a preview screen for the color conversion process so that the user is able to select a color conversion function that is suitable for the user's needs and/or desires.

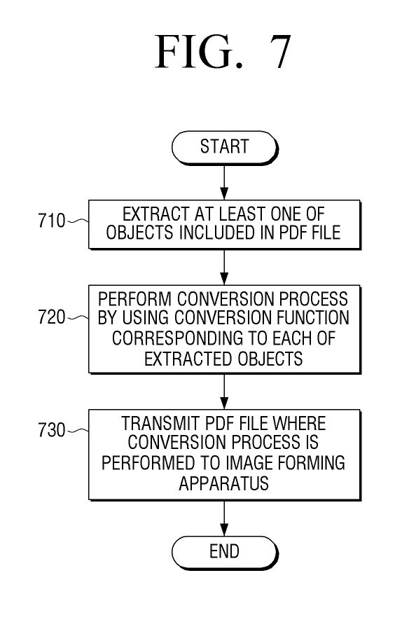

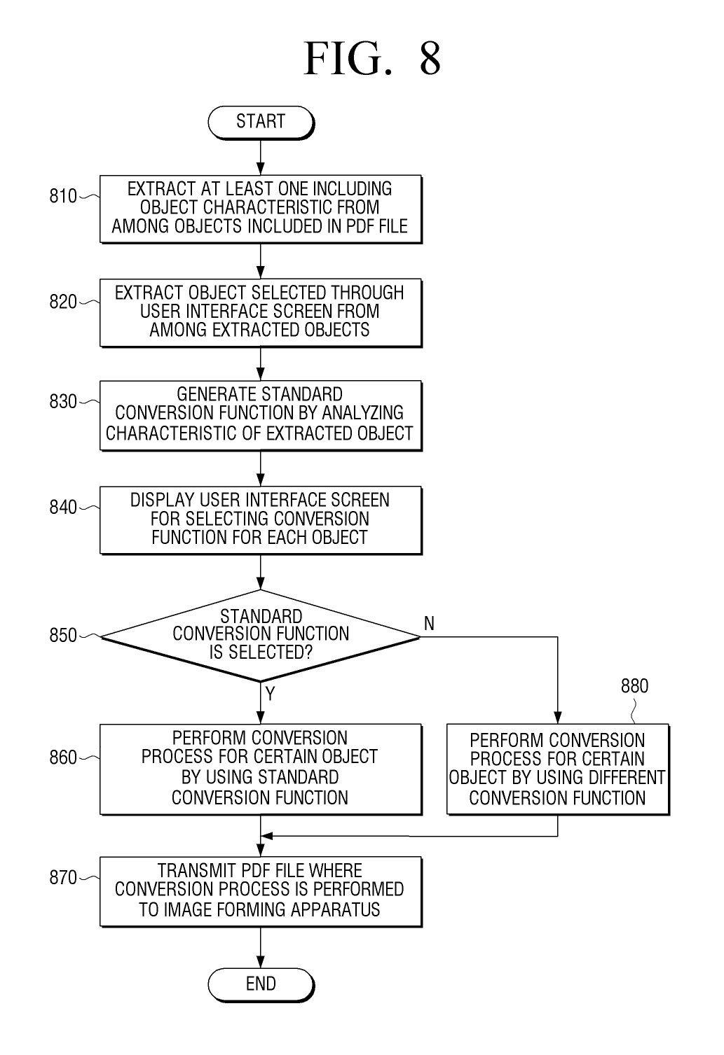

FIG. 7 illustrates a method for processing a file according to an exemplary embodiment. The method in FIG. 8 may be performed by the host apparatus 100, 200 connected to the image forming apparatus 300.

The host apparatus 100, 200 may extract at least one of objects included in a PDF file (S710). A PDF file may be a file downloaded and stored through the internet network, or may be a file produced in the host apparatus 100, 200.

The host apparatus 100, 200 performs the conversion process, e.g., color conversion process by using a conversion function, e.g., color conversion function corresponding to each of the extracted objects (S720), and transmits a PDF file where the conversion process, e.g., color conversion process is performed to the image forming apparatus 300 (S730). In this case, the PDF file may be transmitted to the image forming apparatus 300 along with a printing command.

The host apparatus 100, 200 may display the PDF file where the color conversion process is performed on a screen. The host apparatus 100, 200 may store the PDF file where the color conversion process is performed by overwriting the PDF file with a pre-stored PDF file, or may store the PDF file separately from the pre-stored PDF file.

FIG. 8 illustrates a method for processing a file according to an exemplary embodiment. The method in FIG. 8 may be performed by the host apparatus 100, 200 connected to the image forming apparatus 300.

The host apparatus 100, 200 extracts at least one object including an object characteristic from among objects included in a PDF file (S810).

The host apparatus 100, 200 extracts an object selected through the user interface screen from among the extracted objects (S820). The host apparatus 100, 200 may display at least one object including the object characteristic through the list screen, and may extract an object selected from the list screen as an object that requires the color conversion.

The host apparatus 100, 200 generates a standard color conversion function by analyzing the characteristic of the extracted object (S830).

The host apparatus 100, 200 displays a user interface screen for selecting a color conversion function for each object (S840). The user interface screen may be the selection screen 600 as illustrated in FIG. 6. A user may select a standard color conversion function or a different color conversion function where the standard color conversion function is changed for each object through the selection screen. A preview screen where the standard color conversion function or the different color conversion function selected by the user may be applied to an object may be displayed.

When a standard color conversion function for a certain object is selected through the user interface screen (S850), the host apparatus 100, 200 performs the color conversion process for the object by using the standard color conversion function (S860).

When the different color conversion function for the certain object is selected through the user interface screen (S850), the host apparatus 100, 200 performs the color conversion process for the object by using the different color conversion function (S880).

The PDF file where the color conversion process is performed in S860 and S880 is transmitted to the image forming apparatus 300 along with the printing command (S870). Accordingly, the PDF file may be edited in an object unit, and outputted through the image forming apparatus 300.

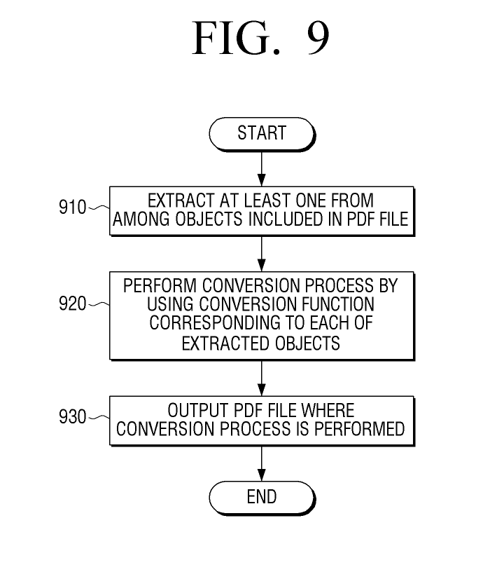

FIG. 9 illustrates a method for processing a file according to an exemplary embodiment. The method in FIG. 9 may be performed by the image forming apparatus 300 connected to the host apparatus 100, 200.

The image forming apparatus 300 extracts at least one of objects included in a PDF file (S910). A PDF file may be a file downloaded and stored through the internet network, and may be a file received along with the printing command from the host apparatus 100, 200.

The image forming apparatus 300 performs the color conversion process by using a color conversion function corresponding to each of the extracted objects (S920), and outputs the PDF file where the color conversion process is performed on a printing paper (S930).

The image forming apparatus 300 may store the PDF file where the color conversion process is performed by overwriting the PDF file with the pre-stored PDF file, or may store the PDF file separately from the pre-stored PDF file.

According to an exemplary embodiment, it is possible to perform the color conversion process for only an object that requires the color conversion process without editing the entire PDF file by extracting at least one object that requires the color conversion process from a PDF file and performing the color conversion for each of the extracted objects.

According to an exemplary embodiment, by providing a user interface screen for receiving a selection of an object for the color conversion process and a color conversion function for the object, a user is able to edit a PDF file more easily.

An exemplary method for processing a file or the method of outputting a file may be implemented as a program including an algorithm that is executable on a computer. An exemplary program may be stored in a non-transitory computer readable medium.

A non-transitory computer readable medium may be defined as a medium that semi-permanently stores data and may be readable by a device. Various applications and programs may be stored and provided in the non-transitory computer readable medium, such as a compact disc (CD), a digital versatile disk (DVD), a hard disk, a Blu-ray disk, a universal serial bus (USB), a memory card, and a read-only memory (ROM), and the like.

Although a few exemplary embodiments have been illustrated and described, the present disclosure is not limited to the aforementioned particular exemplary embodiments, and could be variously modified and achieved by those skilled in the art to which the present disclosure pertains.

What is claimed is:

1. A host apparatus connectable to an image forming apparatus, the apparatus comprising:
an object extractor configured to extract at least one object that requires color conversion from among objects included in a portable document format (PDF) file;
a color conversion processor configured to perform a color conversion process for the extracted object by using a color conversion function; and
a communication interface configured to transmit the PDF file where the color conversion process is performed to the image forming apparatus.

2. The host apparatus as claimed in claim 1, wherein the object extractor comprises:
a first extractor configured to respectively determine whether all objects included in the PDF file include at least one predetermined object characteristic, and extract an object including the at least one object characteristic according to a determined result, and
a second extractor configured to, upon at least one object being selected from the objects extracted by the first extractor, extract the at least one selected object.

3. The host apparatus as claimed in claim 2, wherein the at least one predetermined object characteristic is at least one of an image characteristic, a text characteristic, a graphic characteristic, and a color characteristic.

4. The host apparatus as claimed in claim 1, further comprising:
a user interface configured to provide a user interface screen for receiving a selection of a color conversion function corresponding to each of the extracted objects.

5. The host apparatus as claimed in claim 4, wherein the color conversion processor comprises:
a color conversion function generator configured to analyze characteristic of the extracted objects, and generate a standard color conversion function corresponding to each of the extracted objects;
a color conversion function provider configured to, upon a color conversion function different from the standard color conversion function being selected for each of the objects through the user interface screen, provide the selected color conversion function, and upon the standard color conversion function being selected, provide the standard color conversion function; and
a processor configured to perform color conversion process for each of the extracted objects by using a color conversion function provided from the color conversion function provider.

6. The host apparatus as claimed 5, further comprising:
a controller configured to control the user interface to display a preview screen where one of the color conversion function and the standard color conversion function selected through the user interface screen is applied to the object.

7. The host apparatus as claimed in claim 6, further comprising a storage configured to store the PDF file,
wherein the controller stores a PDF file where color conversion process is performed by the color conversion processor in the storage.

8. The host apparatus as claimed in claim 1, wherein the color conversi [symbol] on function comprises:
at least one of a brightness characteristic value, a contrast characteristic value, a saturation characteristic value, and a color balance characteristic value to be used in color conversion of each of the extracted objects.

9. A host apparatus connectable to an image forming apparatus, the host apparatus comprising:
a user interface configured to display objects included in a portable document format (PDF) file, and receive a selection of a method of processing color conversion for the object; and
a controller configured to control the user interface to display a preview screen where the selected color conversion processing method is applied to the object.

10. The host apparatus as claimed in claim 9, wherein the controller controls the user interface to display an original screen of the object on a side of the preview screen.

11. The host apparatus as claimed in claim 9, wherein upon one of the standard color conversion function for the object and color conversion function different from the standard color conversion function being selected, the user interface selects the selected color conversion function as the color conversion processing method.

12. The host apparatus as claimed in claim 11, wherein the selected color conversion function comprises:
at least one of a brightness characteristic value, a contrast characteristic value, a saturation characteristic value, and a color balance characteristic value to be used in color conversion of each of the extracted objects.

13. An image forming apparatus comprising:
an object extractor configured to extract at least one object that requires color conversion from among objects included in a portable document format (PDF) file;
a color conversion processor configured to perform a color conversion process for the extracted object by using a color conversion function; and
an output unit configured to output a PDF file where the color conversion process is performed.

14. A method for processing a file of a host apparatus connectable to an image forming apparatus, the method comprising:
extracting at least one object that requires color conversion from among objects included in a portable document format (PDF) file;
performing a color conversion process for the extracted object by using a color conversion function corresponding to the extracted object; and
transmitting a PDF file where the color conversion process is performed to the image forming apparatus.

15. The method as claimed in claim 14, wherein the extracting at least one object comprises:
respectively determining whether all objects included in the PDF file include at least one predetermined object characteristic;
extracting an object including the at least one object characteristic according to a determined result; and
when at least one object is selected from the extracted objects, extracting the at least one selected object.

16. The method as claimed in claim 15, wherein the at least one predetermined object characteristic is at least one of an image characteristic, a text characteristic, a graphic characteristic, and a color characteristic.

17. The method as claimed in claim 14, wherein the performing a color conversion process for the extracted objects comprises:
analyzing a characteristic of the extracted object and generating a standard color conversion function corresponding to the extracted object,
upon a color conversion function different from the standard color conversion function being selected for the object through the user interface screen, providing the selected color conversion function, and upon the standard color conversion function being selected, providing the standard color conversion function, and
performing a color conversion process for the extracted objects by using the provided color conversion function.

18. The method as claimed in claim 17, wherein the performing a color conversion process for each of the extracted objects comprises:
displaying a preview screen where any one of the color conversion function and the standard color conversion selected through the user interface screen function is applied to the object.

19. The method as claimed in claim 14, further comprising:
displaying a PDF file where the color conversion process is performed on a screen; and
storing the PDF file where the color conversion process is performed on the storage.

20. The method as claimed in claim 14, wherein the color conversion function comprises at least one of a brightness characteristic value, a contrast characteristic value, a saturation characteristic value, and a color balance characteristic value to be used in color conversion of each of the extracted objects.

21. A non-transitory computer readable recording medium including a program executing a method of processing file as claimed in claim 14.
